(19) United States
(12) Patent Application Publication
(10) Pub. No.: US 2025/0200276 A1
(43) Pub. Date: Jun. 19, 2025

(54) Systems and methods for automatically generating designs

(71) Applicant: Canva Pty Ltd, Surry Hills (AU)

(72) Inventors: William Edward John RADFORD, Rockdale (AU); Ryan Arthur Robert RUSHTON, Carina (AU); Wade Daniel JENSEN, Fortitude Valley (AU)

(73) Assignee: Canva Pty Ltd, Surry Hills (AU)

(21) Appl. No.: 18/974,572

(22) Filed: Dec. 9, 2024

(30) Foreign Application Priority Data
Dec. 13, 2023 (AU) 2023282247

(51) Int. Cl. G06F 40/186

(52) U.S. Cl. CPC G06F 40/186

(57) ABSTRACT

Described herein is a computer implemented method for automatically generating a design including one or more pages. The method includes: receiving, at a computer system, an input prompt for generating the design, the input prompt comprising a topic for the design; generating, by the computer system, page outlines for each of the one or more pages based on the input prompt, each page outline including a page type and a headline; generating, by the computer system, page elements for each of the pages based on the page type and the headline for each of the one or more pages, wherein the page elements includes at least one of text content or media content; and generating, by the computer system, the design including the one or more pages based on the respective page elements, wherein each page of the design displays the page elements of the respective page.

### INCORPORATION BY REFERENCE

This application is a U.S. Non-Provisional Application that claims priority to Australian Patent Application No. 2023282247, filed 13 Dec. 2023, which is hereby incorporated by reference in its entirety. The entire contents of Australian standard application No. 2023210536 for Systems and methods for processing designs, filed on 31 Jul. 2023, are herein incorporated by reference.

### TECHNICAL FIELD

Aspects of the present disclosure are directed to systems and methods for automatically generating designs.

### BACKGROUND

Computer applications for creating and working with designs exist. Some such applications may provide users with the ability to manually create designs in different formats. Such applications allow users to create a design by, for example, creating one or more pages and adding design elements to those pages.

However, the manual generation of designs is generally a time consuming and, at times, complex task requiring generation of text content and retrieval of suitable media content tailored to the design topic or theme.

Accordingly, there exists a need for more intelligent computer applications that can assist users in creating designs.

### SUMMARY

Described herein is a computer implemented method for automatically generating a design including one or more pages, the method including: receiving, at a computer system, an input prompt for generating the design, the input prompt comprising a topic for the design; generating, by the computer system, page outlines for each of the one or more pages, wherein generating each page outline includes generating a page type and a headline based on the input prompt; generating, by the computer system, page elements for each of the pages based on the page type and the headline for each of the one or more pages, wherein the page elements includes at least one of text content or media content; and generating, by the computer system, the design including the one or more pages based on the respective page elements, wherein each page of the design displays the page elements of the respective page.

Also disclosed herein is a computer processing system including: one or more processing units; and one or more non-transitory computer-readable storage media storing instructions, which when executed by the one or more processing units, cause the one or more processing units to perform the above-described method.

Furthermore, disclosed herein is one or more non-transitory storage media storing instructions executable by one or more processing units to cause the one or more processing units to perform the above-described method.

### BRIEF DESCRIPTION OF THE DRAWINGS

In the drawings:

FIG. 1 is a diagram depicting an example network environment for performing various features of the present disclosure.

FIG. 2 is a block diagram of an example computer processing system.

FIG. 3 is a process flowchart depicting operations to generate designs.

FIG. 4 is a process flowchart depicting operations to generate page outlines.

FIG. 5 is a process flowchart depicting operations to generate page plans.

FIG. 6 is a process flowchart depicting operations to retrieve media items.

FIG. 7 is a process flowchart depicting operations to generate and output a design.

FIG. 8 depicts an example of an output design.

FIG. 9 is an example user interface for receiving user input.

While the description is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the scope of the present invention as defined by the appended claims.

### DETAILED DESCRIPTION

In the following description, numerous specific details are set forth in order to provide a thorough understanding of the present invention. It will be apparent, however, that the present invention may be practiced without these specific details. In some instances, well-known structures and devices are shown in block diagram form in order to avoid unnecessary obscuring.

As discussed above, computer applications for creating and managing designs exist. Such applications may provide mechanisms for a user to create a design, edit the design by adding content to it, and output the design in various ways (e.g. by saving, displaying, printing, publishing, sharing, or otherwise outputting the design).

In one example, a computer application may provide a user with the ability to create and manage deck-format designs. A deck-format design stores content and associated metadata in a slide deck type format. Such deck-format designs or presentations, generally as a collection or deck of pages or slides, are widely used to present on various topics, for example, in relation to a report or a pitch. Typically, these types of designs will include text content about a topic distributed across the pages and will often include media content such as images, audio, or videos accompanying the text content. For ease of reference, a deck-format design may also be referred to as a deck in this disclosure.

At a general level, creating a deck involves a user generating multiple pages of text content and creating, retrieving and/or selecting suitable media items such as images, audio clips, or videos to accompany the text content. The user then manually arranges the text content and/or media items on each page of the deck and orders the respective pages. This can be a cumbersome and time intensive exercise for a user and may often result in poorly created decks—e.g., decks that do not include suitable media items that relate to the topic or theme of the deck.

Embodiments of the present disclosure are directed to systems and methods for automatically and intelligently generating deck-format designs based on input prompts. To do so, the systems and methods are configured to analyse an input prompt and automatically generate content for the deck-format design based on the input prompt. In particular, the systems and methods initially generate page outlines for a predetermined set of pages in the deck-format design. As referred to herein, a page outline indicates a theme or topic for a page and also indicates the type of content a page should have. Each page outline generally includes a page headline (indicating, for example, the theme or topic for the page) and a page type (indicating, for example, the type of content the page should have). Examples of page type include, a title page type that only includes a headline, a paragraph page type that includes one or more paragraphs of text, a list page type that includes a list of bullet points, or a quote page type that includes, for example, an inspirational quote).

The systems and methods may further be configured to generate page elements for each page based on at least the respective page types and headlines. As referred to herein, page elements refer to text and/or media elements that are displayed on a page of a deck-format design. Page elements in the present disclosure do not necessarily include style elements, however, in some embodiments, could include these as well.

In addition, the systems and methods may be configured to automatically and intelligently identify media items for one or more pages of the deck-format design and include the identified media items in the one or more pages of the deck-format design.

The systems and methods may further be configured to select a deck template from a selection of deck templates based on the page elements and automatically transfer the page elements for each page of the deck into the deck template to generate a new deck-format design.

In some embodiments, a generative machine learning (ML) model may utilized to generate the deck-type design. To this end, the input prompt may be provided to a ML model that is trained to generate page outlines and page text. In case media items are required for a page of the deck, the ML model may also be trained to generate media item queries for a corresponding page.

In some embodiments, a first input prompt is generated and provided to the generative ML model, which is trained to generate one or more page outlines based on the input prompt. The page outlines determine the number of deck pages, the page types, and the headline for each page. A set of second input prompts (based on each of the one or more page outlines) is then generated and provided to the ML model, which is trained to generate page content based on each of the second prompts in the set of second prompts. As referred to herein, the term page content encompasses text that can be displayed on the page and media queries that can be used to search for media items for the respective pages. The ML model may be trained to generate the page content based on the page type, and the headline. For example, it may generate a paragraph of text based on the headline for a paragraph type page or it may generate a list of short sentences based on the headline for a list type page. This way, the page outlines may be provided back to the ML model in a feedback process to further generate corresponding page content, such that the page content eventually ties back to the original input prompt.

The generative ML model may be trained using configuration data and some-shot examples to generate the page outlines and the page content accurately.

The media queries generated by the ML model may be utilized by the presently disclosed systems and methods to search a media library for media items and select a media item for respective pages.

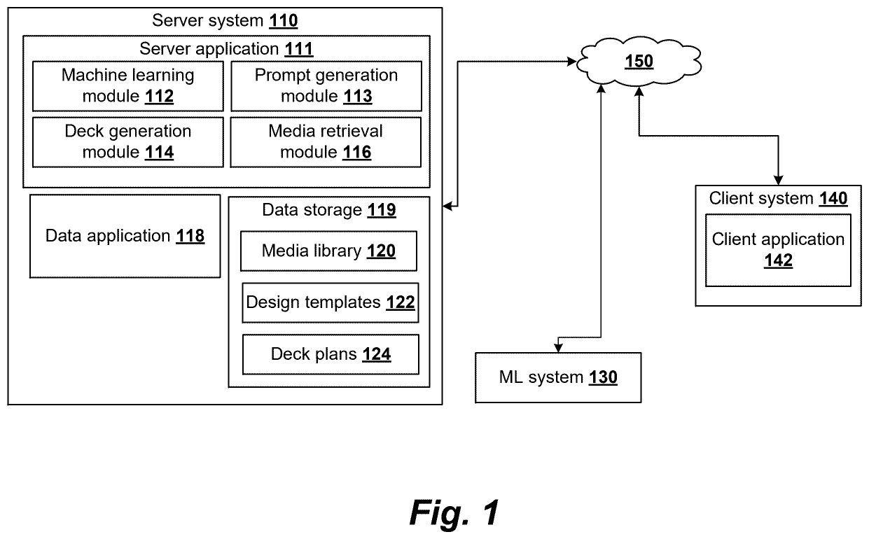

These and other aspects of the present disclosure will now be described with references to FIGS. 1-0.

### Example Systems

The techniques disclosed herein are described in the context of a digital design platform that is configured to facilitate various operations concerned with designs. In the context of the present disclosure, these operations relevantly include automatically creating a deck. A digital design platform may take various forms. In the embodiments described herein, the digital design platform is a client-server type platform (e.g. one or more client applications and one or more server applications that interoperate to perform the described techniques). The techniques described herein can, however, be performed (or be adapted to be performed) by a stand-alone digital design platform (e.g. an application or set of applications that run on a user's computer processing system and perform the techniques described herein without requiring server-side operations).

FIG. 1 depicts a networked environment 100 in which various features of the present disclosure may be implemented. The networked environment 100 includes a server system 110, a ML system 130, and a client system 140, which operate together to perform the operations described herein.

The systems 110-130 communicate with one another via one or more communication networks 150 (e.g., the Internet). For example, the client system 140 communicates with the server system 110 via public internetwork, whereas the server system 110 may communicate with the ML system 130 via a local or public area network.

The server system 110 is a system entity that hosts one or more computer applications and/or content. The server system 110 may include one or more server computing systems or nodes for hosting a server application 111 and one or more storage devices (e.g., storage device 119) for storing application specific data. An example of a server application hosted by the server system 110 includes a digital design application (e.g., Canva designs).

The server system 110 may execute to provide a client application endpoint that is accessible over the communication network 150. In some examples, the server system 110 is a web server, which serves web browser clients and receives and responds to HTTP requests. In another example, the server system 110 is an application server, which serves native client applications and is configured to receive, process, and respond to specifically defined API calls received from those client applications. The server system 110 may include one or more web server applications and/or one or more application server applications allowing it to interact with both web and native client applications.

While a single server architecture has been described herein, it will be appreciated that the server system 110 can be implemented using alternative architectures. For example, in certain cases a clustered architecture may be used where multiple server computing instances (or nodes) are instantiated to meet system demand. Communication between the applications and computer processing systems of the server system 110 may be by any appropriate means, for example direct communication or networked communication over one or more local area networks, wide area networks, and/or public networks (with a secure logical overlay, such as a VPN, if required). Conversely, in the case of small enterprises with relatively simple requirements the server system 110 may be a stand-alone implementation (i.e. a single computer directly accessed/used by the client).

The server application 111 (and/or other applications of server system 110), in conjunction with client application 142, facilitates various functions related to digital designs. These may include, for example, design creation, editing, organisation, searching, storage, retrieval, viewing, sharing, publishing, and/or other functions related to digital designs. The server application 111 may also facilitate additional, related functions such as user account creation and management, user group creation and management, and user group permission management, user authentication, and/or other server side functions.

To perform the functions described herein, the server application 111 includes a number of software modules, which provide various functionalities and interoperate to automatically generate deck type designs. These modules are discussed below and include: a machine learning module 112; a prompt generation module 113; a deck generation module 114; and a media retrieval module 116.

The ML module 104 is configured to communicate with a machine learning (ML) model over network 150. In particular, it is configured to provide one or more input prompts to the ML model and receive one or more outputs from the ML model. The outputs may include page outlines and page content.

The prompt generation module 113 is configured to receive user prompts from client systems 1401 and generate one or more page outline prompts and page content prompts for the ML system 130. The deck generation module 114 is configured to maintain a record of an in-progress deck-format design (the record referred to more generally as a design descriptor or more particularly as a deck plan descriptor in this disclosure), select a design template for the deck and generate a final deck-format design. The media retrieval module 116 is configured to search for and retrieve media items (e.g. images and videos), for example, by searching a media library 120 in data storage 119.

The server application 111 may further include a data storage application 118, which is configured to receive and process requests to persistently store and retrieve, to and from data storage 119, data relevant to the operations performed/services provided by the server application 111. Such requests may be received from the server application 111, other server environment applications, and/or (in some instances) directly from client applications such as 142.

The data storage application 118 may, for example, be a relational database management application or an alternative application for storing and retrieving data from data storage 119. Data storage 119 may be any appropriate data storage device (or set of devices), for example one or more non transient computer readable storage devices such as hard disks, solid state drives, tape drives, or alternative computer readable storage devices. Furthermore, while a single instance of data storage 119 is described, server system 110 may include multiple instances of data storage.

The data storage stores data relevant to the operations performed/services provided by the server application 111. In particular, it stores design templates 122 (e.g. design records that can be used to create designs), and deck records 124.

As used herein, design templates 122 refer to templates including a plurality of destination elements configured to receive design elements from a source design. Templates may thus provide a structure to positon the content of a deck for display. A deck-format design template 122 may include a set of ordered page templates. Each page template may include one or more destination elements of various types configured to receive a design element of a corresponding type from a source design. Destination elements may be positioned at (or configured to position source elements at) predetermined locations on a page, for example, at particular x and y coordinates and/or occupying particular ranges of pixels of a page having a predetermined resolution. Destination elements may also include style attributes for example, colours, fonts and the like which may be applied to source elements when populated into the destination element. A vast variety of design templates, deck templates, page templates, destination elements, style attributes, and permutations thereof are possible.

As one example, a deck-format design template 122 may have a title page template; a body page template; and a conclusion page template. The title page template may include destination elements of a heading placeholder element and an image placeholder element; the body page template may include destination elements of a sub-heading placeholder element and a body text placeholder element; and the conclusion page template may include a body text placeholder element. Image placeholder elements may be configured as destination elements to receive an image of a particular size, resolution and/or aspect ratio. Each text placeholder may be configured to respectively receive a heading, sub heading, or body-text of a particular length (number of characters, words, or sentences) and/or in a particular form (paragraph, bullet points, or the like). Each of such placeholder elements may also include one or more style attributes. For example, a heading placeholder element may include a bold font style attribute; a sub-heading placeholder element may include an underline style attribute; and a body text placeholder may include an easy to read font style attribute.

Each deck generated by the systems and methods disclosed herein may be associated with a deck record 124. A deck record 124 is a set of key/value pairs that define attributes of the deck. A deck record 124 may define various deck attributes, such as a deck ID, which uniquely identifies the deck, number of deck pages, and identifiers of each of the pages in the deck. The deck record 124 may also include an identifier of a design template 122 used in the deck. Additional and/or alternative deck-level attributes are also possible (for example, attributes such as a version identifier, a creation date, a creator, default dimensions of pages in the deck and/or other attributes). As one example, a table storing deck records 124 may be as follows:

TABLE A
Example deck record

| Deck ID | No. of pages | Page IDs | Deck template ID |
|---|---|---|---|
| 1 | 4 | 1, 2, 3, 4 | 23876 |
| 2 | 6 | 1, 2, 3, 4, 5, 6 | 38489 |
| . . . | 3 | 1, 2, 3 | 89472 |
| n | 9 | 1, 2, 3, 4, 5, 6, 7, 8, 9 | 38947 |

For each deck record 124, the table stores a deck ID, number of pages in the deck, identifiers of each page in the deck, and an identifier of a design template 122 used for the deck. Many alternative deck attributes and deck record structures are possible. For example, while the above is shown as a table, deck record 124 may also store page identifiers in an ordered list, such as Page data: “pages”: [{page1 ID}, . . . {pagen ID}].

For each deck record, the server application 111 also stores page records for each page associated with a deck record. Each page record may be identified by the deck ID of the corresponding deck record and the position of the page in the deck. In this example, a page record's position in the deck serves to identify that page and also defines its position in the deck (e.g., a page at array index n appears after a page at array index n−1 and before a page at array index n+1).

Each page record may also be a set of key/value pairs that define attributes of a respective page. Page attributes may include—
a page ID for uniquely identifying each page, a page type that indicates a type or category of the page which defines (or is associated with) particular requirements and configurations,
a page headline including e.g. a string of characters that represents or summarises a concept or theme of (or associated with) the respective page. The page headline need not be actually displayed as a heading, sub-heading, or the like in the ultimate output of a generated deck. Instead, the page headline may be used as a further input for generating page content such that, for example, the text content or media items express (or correspond to) the theme of the page headline. Thus, in some ways, page outlines may be expanded (or extended) to generate page content.
page text content that includes, for example, a string of characters in a single paragraph or a set of bullet points that is based on the page headline, and
page media content (e.g., identifier(s) of media items). Media items may be images, videos, fill type content or the like. Media items may be stored in the page record directly or as a link to a media item library.

An example page record is shown in the table B.

TABLE B
Example deck page record

| Field | Value |
|---|---|
| Deck Identifier | 2 |
| Page identifier | 1 |
| Page type | Title |
| Page headline | ABC |
| Text content | Xxxxx |
| Media Identifier | 324763 |

In the above example, where applicable, fields may have a null value. For example, where a page does not include a media item, the respective field may have a null value. Many alternative page attributes and page record structures are possible.

In addition to deck plans and design templates, the data storage 119 may further store a media library 120 including a plurality of media items such as images and videos.

Returning to FIG. 1, the ML system 130 hosts one or more generative ML models that may be configured to generate outputs based on input prompts. In particular, the ML system 130 may be configured to receive a first input prompt (e.g., a page outline prompt) and generate a set of page outlines based on the first input prompt. It also receives a set of second input prompts (e.g., page content prompts) and is trained to generate page content based on the set of second input prompts.

In some embodiments, the ML system 130 may be a large language model (LLM) that is trained as a general purpose ML model that can be used to generate different types of text based outputs. In the present case, if a general purpose ML model is used, it is additionally trained to perform specific tasks. For example, the general purpose ML model may be trained to generate text (e.g. page outlines and page content described above) from a prompt. In other embodiments, the ML model may be a more specific model that is trained to generate the outputs described above.

Further still, in some examples, the ML system 130 may be associated with and owned by the same party that operates the server system 110. In this case, the ML system 130 may be part of the server system 110. In other examples, the ML system 130 may be owned by a third party and that independent of the party that owns the server system 110. Examples of third party LLMs include OpenAI's ChatGPT4, and Google's Bard.

The client system 140 may be a desktop computer, laptop computer, tablet computing device, mobile/smart phone, or other appropriate computer processing system. The client system 140 hosts a client application 142 which, when executed by the client system 140, configures the client system 140 to provide client-side functionality/interact with server system 110 (or, more specifically, the server application 111 and/or other applications provided by the server system 110). Via the client application 142, and as discussed in detail below, a user can access and make use of the various techniques and features described herein—e.g., the user can input prompts to generate deck-format designs, view and preview deck-format designs, edit, or publish one or more deck-format designs, etc. Client application 142 may also provide a user with access to additional design related operations, such as creating, editing, saving, publishing, sharing, and/or other design related operations.

The client application 142 may be a general web browser application which accesses the server application 111 via an appropriate uniform resource locator (URL) and communicates with the server application 111 via general world-wide-web protocols (e.g. http, https, ftp) over communications network 150. Alternatively, the client application 142 may be a native application programmed to communicate with server application 111 using defined API calls and responses. A given client system such as 140 may have more than one client applications 142 installed and executing thereon. For example, a client system 140 may have a (or multiple) general web browser application(s) and a native client application.

The present disclosure describes various operations that are performed by server application 111 and client application 142. However, operations described as being performed by a particular application (e.g. server application 111) could be performed by (or in conjunction with) one or more alternative applications (e.g. client application 142), and/or operations described as being performed by multiple separate applications could in some instances be performed by a single application.

In the present example, server system 100 is configured to perform the functions described herein by execution of a software application (or a set of software applications) 111—that is, computer readable instructions that are stored in a storage device (such as non-transient memory 210 described below) and executed by a processing unit of the system 200 (such as processing unit 202 described below). Similarly, client system 140 is configured to perform functions described herein by execution of software application 142 stored in a storage device and executed by a processing unit of a corresponding system.

### Example System

The techniques and operations described herein are performed by one or more computer processing systems. By way of example, client system 140 may be any computer processing system which is configured (or configurable) by hardware and/or software—e.g. client application 142—to offer client-side functionality. Similarly, the server application 111 is also executed by one or more computer processing systems (the server system 110).

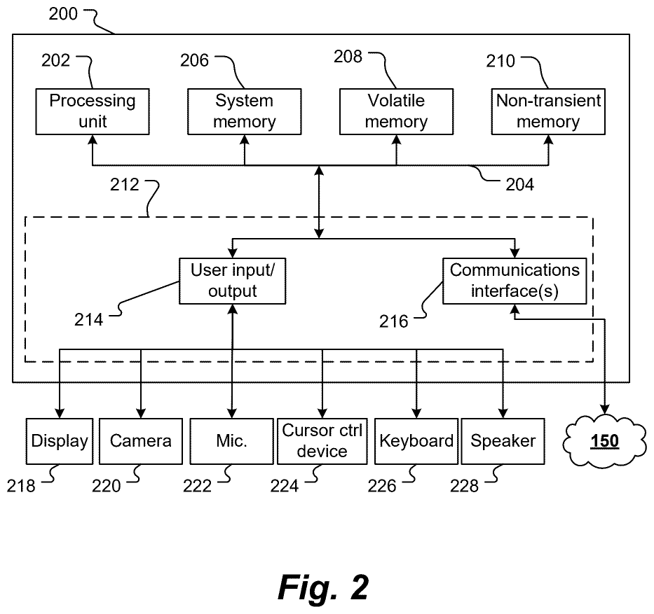

FIG. 2 provides a block diagram of a computer processing system 200 configurable to implement embodiments and/or features described herein. For example, systems 110, 130, and 140 of FIG. 1 may be (or include) a computer processing system such as that shown in FIG. 2 (though alternative architectures are possible).

System 200 is a general purpose computer processing system. It will be appreciated that FIG. 2 does not illustrate all functional or physical components of a computer processing system. For example, no power supply or power supply interface has been depicted, however system 200 either carries a power supply or is configured for connection to a power supply (or both). It will also be appreciated that the particular type of computer processing system will determine the appropriate hardware and architecture, and alternative computer processing systems suitable for implementing features of the present disclosure may have additional, alternative, or fewer components than those depicted.

Computer processing system 200 includes at least one processing unit 202. The processing unit 202 may be a single computer processing device (e.g. a central processing unit, graphics processing unit, or other computational device), or may include a plurality of computer processing devices. In some instances, where a computer processing system 200 is described as performing an operation or function all processing required to perform that operation or function will be performed by processing unit 202. In other instances, processing required to perform that operation or function may also be performed by remote processing devices accessible to and useable (either in a shared or dedicated manner) by system 200.

Through a communications bus 204 the processing unit 202 is in data communication with a one or more machine readable storage (memory) devices, which store computer readable instructions, and/or data, which are executed by the processing unit 202 to control operation of the processing system 200. In this example, system 200 includes a system memory 206 (e.g. a BIOS), volatile memory 208 (e.g. random access memory such as one or more DRAM modules), and non-transient memory 210 (e.g. one or more hard disk or solid state drives).

System 200 also includes one or more interfaces, indicated generally by 212, via which system 200 interfaces with various devices and/or networks. Other devices may be integral with system 200, or may be separate. Where a device is separate from system 200, the connection between the device and system 200 may be via wired or wireless hardware and communication protocols, and may be a direct or an indirect (e.g. networked) connection.

Generally, and depending on the particular system in question, devices to which system 200 connects include one or more input devices to allow data to be input into/received by system 200 and one or more output device to allow data to be output by system 200. Example devices are described below, however it will be appreciated that not all computer processing systems will include all mentioned devices, and that additional and alternative devices to those mentioned may well be used.

For example, system 200 may include or connect to one or more input devices by which information/data is input into (received by) system 200. Such input devices may, for example, include a keyboard, a pointing device (such as a mouse or trackpad), a touch screen, and/or other input devices. System 200 may also include or connect to one or more output devices controlled by system 200 to output information. Such output devices may, for example, include one or more display devices (e.g. a LCD, LED, touch screen, or other display devices) and/or other output devices. System 200 may also include or connect to devices which act as both input and output devices, for example touch screen displays (which can receive touch signals/input and display/output data) and memory devices (from which data can be read and to which data can be written).

By way of example, where system 200 is an end user device such as (such as system 140), it may include a display 218 (which may be a touch screen display), a camera device 220, a microphone device 222 (which may be integrated with the camera device), a cursor control device 224 (e.g. a mouse, trackpad, or other cursor control device), a keyboard 226, and a speaker device 228.

System 200 also includes one or more communications interfaces 216 for communication with a network, such as network 150 of FIG. 1. Via the communications interface(s) 216, system 200 can communicate data to and receive data from networked systems and/or devices.

System 200 may be any suitable computer processing system, for example, a server computer system, a desktop computer, a laptop computer, a netbook computer, a tablet computing device, a mobile/smart phone, a personal digital assistant, or an alternative computer processing system.

System 200 stores or has access to computer applications (which may also referred to as computer software or computer programs). Generally, such applications include computer readable instructions and data which, when executed by processing unit 202, configure system 200 to receive, process, and output data. Instructions and data can be stored on non-transient machine readable medium such as 210 accessible to system 200. Instructions and data may be transmitted to/received by system 200 via a data signal in a transmission channel enabled (for example) by a wired or wireless network connection over an interface such as communications interface 216.

Typically, one application accessible to system 200 will be an operating system application. In addition, system 200 will store or have access to applications which, when executed by the processing unit 202, configure system 200 to perform various computer-implemented processing operations described herein. For example, and referring to the networked environment of FIG. 1 above, server system 110 includes one or more systems 200, which run a server application 111. Similarly, client system 140 runs a client application 142.

In the present disclosure, application 142 is configured to display an input user interface (UI), e.g. on display 218. Server application 111 may communicate with client application 142 to display the input UI. The input UI provides a mechanism for a user to input a prompt for a design and to create, edit, and output designs, such as decks. Various input UI's are possible. One example is graphical user interface (GUI) and the UI will be envisioned as a GUI in the following description. While a GUI is provided as an example, alternatives input UI's are also possible. As another example, the input UI may be a command line interface type UI that a user can use to provide prompts, media items and media item identifiers (e.g. file locations or other identifiers) and selections that are to be used in the design generation. The UI also allows a user to access and perform other functionality described herein. By way of example, the UI may include a prompt input region, which can be used by a user to input a prompt. The UI may also include functionality to display design options to a user for selection, for example the display of candidate, explained further below.

### Example Methods

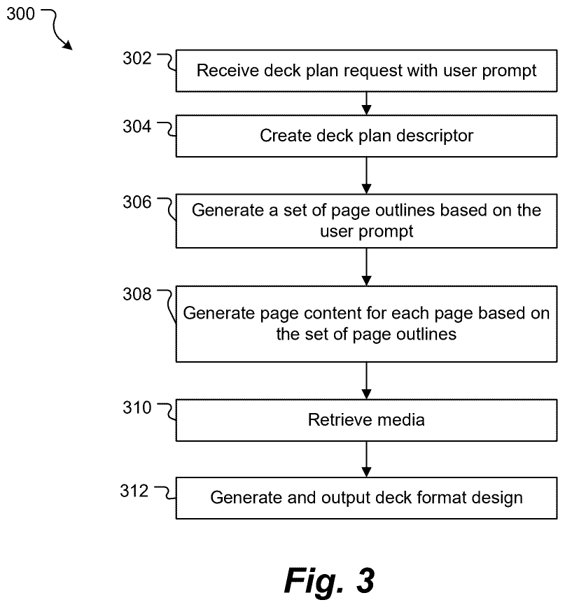

Turning to FIG. 3, a method 300 for automatically generating a design will be described. The operations of method 300 will generally be described as being performed by application 111 (and the various associated modules) running on system 110 in association with client application 142 running on client system 140. The operations could, however, be performed by one or more alternative applications running on system 110 and/or one or more alternative computer systems.

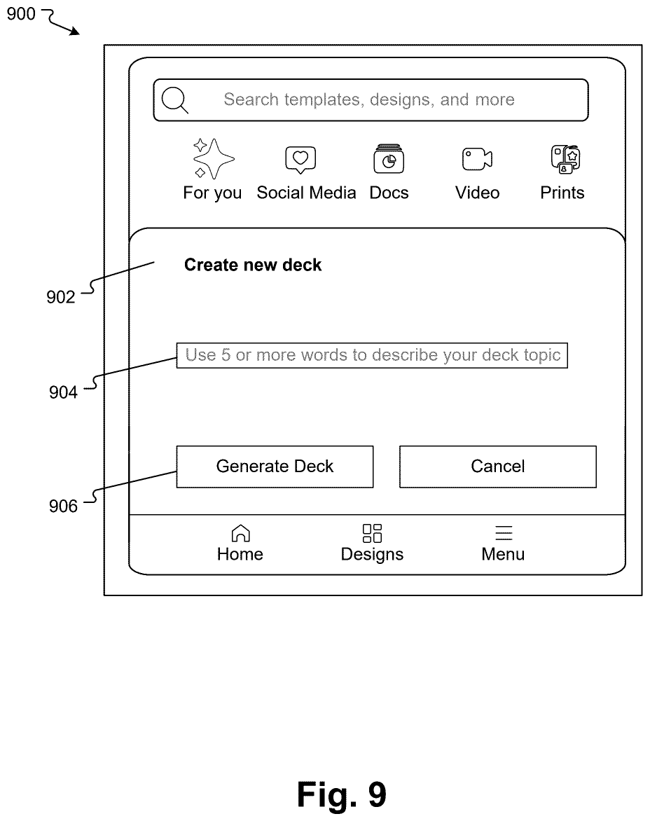

Applications 111 and 142 may be configured to perform method 300 in response to detecting one or more trigger events. As one example, application 111 may communicate with application 142 (e.g. via network 150) to cause application 142 to display a user interface (UI), e.g., user interface 900 displayed in FIG. 9. The UI 900 includes a user input form 902 for creating a new deck. The input form 902 includes a prompt input region 904. The prompt input region 904 may include a text field with placeholder text, for example, of “Use 5 or more words to describe your presentation topic” or alternative text, which directs a user to input their prompt in this region 904. The user input form 902 further includes an interactive control, e.g., “generate deck” control 906. The method 300 may commence when a user inputs a user prompt in the prompt input region 904 and then activates the interactive control 906.

At 302, a request for generating a deck is received at the server application 111. In one example, once the user activates the control 906, the client application 142 creates a request for generating a deck and passes the user prompt along with the request to the server application 111. The user prompt may be in the form of a text string, for example, of 5 or more words.

At 304, the application 111 creates a deck plan descriptor for the received request. In particular, it may generate a unique deck plan identifier and store the deck plan identifier in the deck plan descriptor along with the user input received as part of the request. An example deck plan descriptor at this stage is displayed below in table C—

TABLE C
Example deck plan descriptor after step 304

| | |
|---|---|
| Deck plan identifier | 273278 |
| User prompt | “Generate a 5 page report on a topic” |

Next, at step 306, the application 111 generates a set of page outlines for the deck based on the user prompt. In some embodiments, this includes communicating the user prompt to the ML system 130 along with a request to generate the set of page outlines. The application 111 receives the set of page outlines from the ML system 130 and populates the deck plan descriptor with the received page outlines—the page outlines may be stored in a deck plan field called a page plan. As used herein, the term page plan refers to a field that stores all page-level information generated in method 300, including e.g., for each page, a page type, a headline, page content, and media identifier (if present).

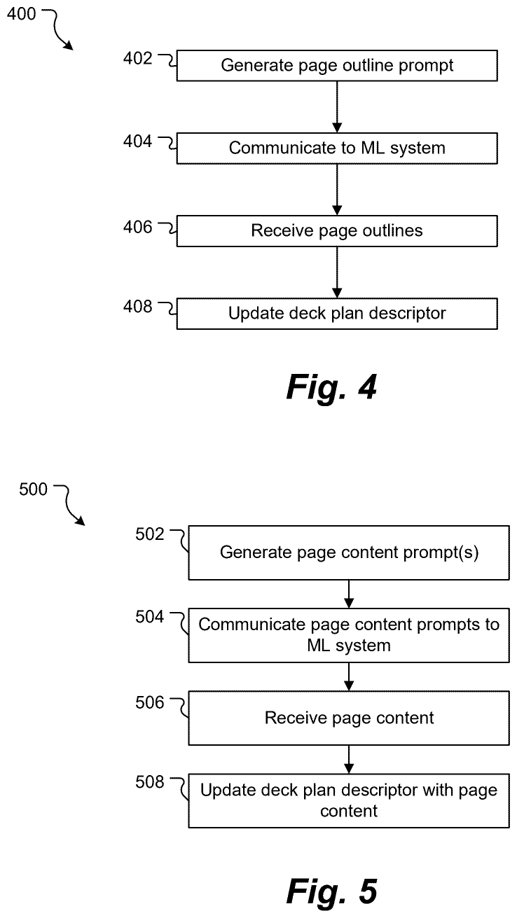

Method step 306 will be described in more detail with reference to FIG. 4. An example deck plan descriptor at this stage is displayed in table D below—

TABLE D
Example deck plan descriptor after step 306

| | |
|---|---|
| Deck plan identifier | 273278 |
| User prompt | “Generate a 5 page report on a topic” |
| Genre | Report |
| Page Plans | [1] Type1, Headline1; |
| | [2] Type2, Headline2; |
| | [3] Type3, Headline3; |
| | [4] Type4, Headline4; |
| | [5] Type5, Headline5. |

At 308, once page outlines are generated, the application 111 generates content for each of the pages based on the page outlines. In some embodiments, to do so, the application 111 generates a second set of user prompts based on the page outlines and communicates this set of prompts to the ML system 130 along with requests for text and/or media queries for the deck. The application 111 receives the content and/or media queries for each of the requested pages from the ML system 130 and populates the deck plan descriptor and in particular the page plan field with the received content and/or media queries. Method step 308 will be described in more detail with reference to FIG. 5. An example deck plan descriptor at this stage is displayed in table E below—

TABLE E
Example deck plan descriptor after step 308

| | |
|---|---|
| Deck plan identifier | 273278 |
| User prompt | “Generate a 5 page report on a [topic]” |
| Genre | Report |
| Page Plans | [1] Outline1; query1, content1 |
| | [2] Outline2; query2, content2 |
| | [3] Outline3; query3, content3 |
| | [4] Outline4; query4, content4 |
| | [5] Outline5; Null, content5 |

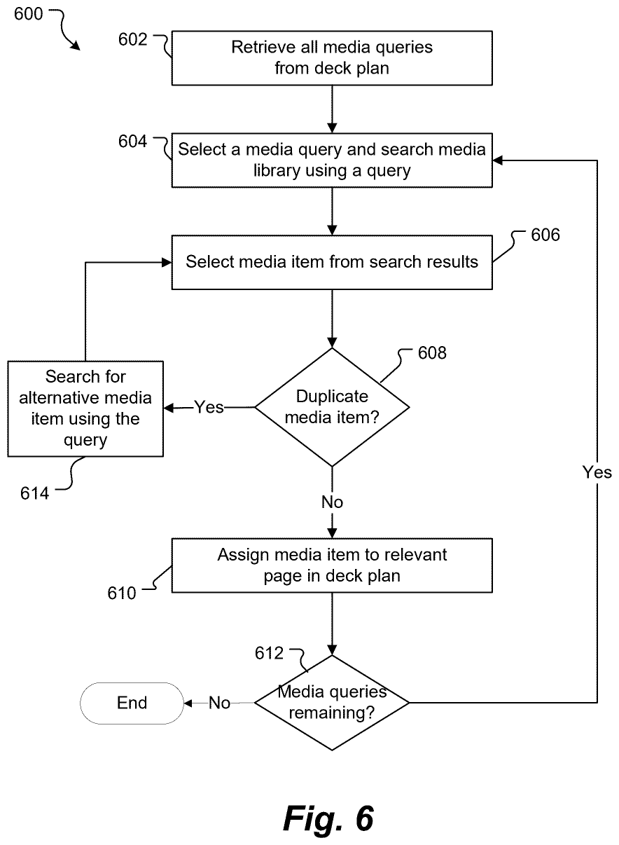

At 310, as will be outlined further below with reference to FIG. 6, media items that match the media queries are retrieved by the application 111 (e.g. via media retrieval module 116 and/or data storage application 118). Retrieving media items includes retrieving, for example images, audio, or videos to be included in the deck. Broadly speaking, each of the media queries in the deck plan descriptor is used to perform a corresponding search for a respective media item in the media library 120, for example. A media item is selected from the search results and the selected media item identifier is then associated with the page plan the corresponding media query is associated with.

An example deck plan descriptor at this stage is displayed in table F below—

TABLE F
Example deck plan descriptor after step 310

| | |
|---|---|
| Deck plan identifier | 273278 |
| User prompt | “Generate a 5 page report on a [topic]” |
| Genre | Report |
| Page Plans | [1] Outline1; query1, content1, MediaID1 |
| | [2] Outline2; query2, content2, mediaID2 |
| | [3] Outline3; query3, content3, mediaID3 |
| | [4] Outline4; query4, content4, mediaID4 |
| | [5] Outline5; Null, content5 |

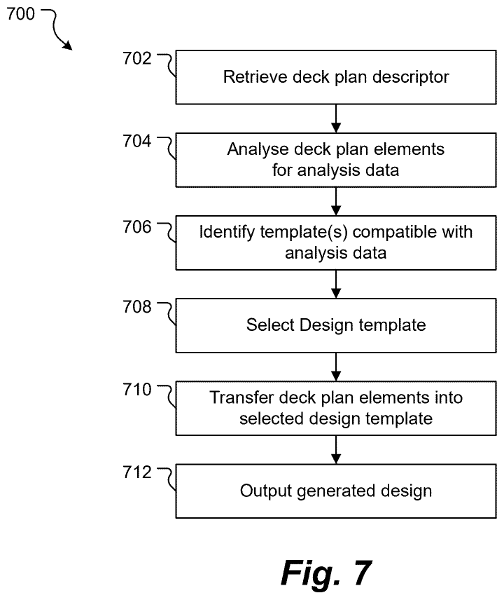

In accordance with steps 302-310 of method 300, the page elements for the deck may be generated and/or retrieved. The method 300 may then proceed to step 312 where the final deck is generated and communicated to the client system 140 for display thereon. At 312, the deck generation module 114 compiles the deck plan descriptor, selects a design template for the deck (based on the page elements of each page), and transfers the page elements into the selected design template, and generates the deck-format design. These steps will be further outlined below, with reference to FIG. 7.

Whilst method 300 is described sequentially, it is also possible to perform steps of the process in alternative orders.

FIG. 4 illustrates a flowchart showing an example method 400 for performing step 306, i.e., generating page outlines, according to embodiments of the present disclosure.

The method 400 commences at step 402, where the user input prompt is provided to the prompt generation module 113 and the prompt generation module 113 generates a page outline prompt. The content of the page outline prompt will depend on the type of ML system 130 being used. If the ML system 130 is a general purpose LLM, the page outline prompt includes the user input prompt and configuration data, which provides instructions to the ML system 130 to generate the page outlines. In case the ML system 130 includes a specific model that has already been trained for the specific task of generating page outlines, the page outline prompt may only include the user input prompt.

The precise format of the configuration data depends on a variety of factors, including the type of LLM (e.g. configuration data for use with OpenAI's ChatGPT may differ from the configuration data required for Google's Bard), the training mechanism of the ML model, and the content of the user input prompt (and/or other available data).

In one example, the configuration data for the page outline prompt may include a task description (e.g., to cue the ML system 130 to generate a desired output in the context of a task), task parameters (e.g., output format, number of pages, tone of the output, rules, etc.) and one or more few-shot training examples of input prompts and the page outlines the ML system 130 is expected to generate based on those input prompts.

The table G below shows an example of the page outline configuration data—

TABLE G
Example page outline configuration data

| | |
|---|---|
| Description of task: | Generate a genre and page outlines for a presentation on a topic |
| | given a prompt |
| Parameters: | Be helpful and creative, and do not use offensive language |
| | Each page outline uses the structure: “type : headline”.” |
| | The types can be: title, paragraph, list, quote, thank you. Title |
| | always comes at the beginning. If used, thank you goes at the |
| | lend. |
| | Start by generating the design category, which can be one of: |
| | story, report, presentation, pitch, quiz, personal, portfolio, or |
| | brainstorming. Generate exactly the number of page asked for, |
| | and, if not otherwise specified, generate 7 to 10 pages. |
| Examples: | User prompt: “A seven page pitch deck about a hydroponic |
| | urban farming startup” |
| | LLM Output: |
| | genre: pitch |
| | [1] title: Harvesting the future: An urban farming startup. |
| | [2] quote: Problem statement |
| | [3] paragraph: Target market |
| | [4] list: Product and services |
| | [5] paragraph: Financials |
| | [6] list: Our team |
| | [7] thank_you: Thanks |

It will be appreciated that the configuration data may include many alternative components and template prompts and that many alternative approaches to generating a prompt are possible. For example, the configuration data may be (or include) a single pre-assembled template prompt—e.g. a string that includes all the relevant set text components. Alternatively, separate prompts may be generated including separate components and combinations thereof. The LLM can thus be configured by providing the configuration data as a prompt, part of a prompt, or series of prompts to the LLM.

In some embodiments, the same configuration data may be used to configure the ML system 130 to generate page outlines every time. In such cases, the page outline configuration data may be predefined and stored in data storage 119. In other embodiments, the configuration data may vary (e.g., depending on user requirements). For example, a user may provide a tone for the deck (e.g., funny) that overrides the preset tone for the deck. In this case, the parameters of the configuration data may be updated to include the user input tone.

At step 402, the prompt generation module 113 retrieves the configuration data from storage 119, determines whether the configuration data needs to be updated (e.g., based on the received user input), and combines the configuration data with the user input prompt to generate the page outline prompt. In one embodiment, the prompt generation module 113 generates the page outline prompt by constructing a text string from one or more component parts of the configuration data and the user input prompt (e.g. by concatenating the component parts and user input prompt together).

At step 404, once the page outline prompt is generated, the prompt generation module 113 communicates the page outline prompt to the ML module 112. The ML module 112 then communicates the page outline prompt to the ML system 130.

By way of the page outline configuration data, the ML system 130 is cued to generate page outlines based, in part, on the user prompt. Based on the example configuration data shown in table G, the ML system 130 may be cued to generate a design category for a deck and between 7-10 page outlines unless otherwise specified in the user prompt. The design category indicates the type of multi-page design and can include, e.g., story, report, presentation, pitch, quiz, personal, portfolio, or brainstorming. The ML system 130 utilizes the design category to generate the page outlines. In particular, the design category provides guidance to the ML system 130 with respect to the types of outlines that can be generated for a given topic. For example, a presentation that tells a story about microfarming will have different page headings as opposed to a presentation for a pitch about microfarming to a venture capitalist. Accordingly, by utilizing the design category, the ML system 130 can generate cohesive page outlines.

The ML system 130 outputs the raw page outlines in accordance with the page outline prompt. Each page outline generated by the ML system 130 has a page type, and a page headline. The page headline of each page outline may be text generated based on the page type and the user prompt. For the plurality of page outlines, the first page outline may be of the title type and, if a thank_you type page is included, it may be the last page outline. The remaining pages may be any order and combination of the other page types.

An example of the output generated by the ML system 130 at this point for a user input, “A pitch deck for my yoga homestay start-up” is provided in the format [Page number] <type>:<headline> in table H below—

TABLE H
Example page outline output

genre: pitch
[1] title: Namaste Homestay: A wellbeing Escape.
[2] quote: Problem statement
[3] List: Target Market
[4] List: Our yoga retreat
[5] Paragraph: Financials
[6] list: Our team
[7] List: Amenities
[8] thank_you: Thanks

At 406, the page outlines output by the ML system 130 are received by the ML module 112 as a string of output text, referred to as a completion.

At 408, the page outlines in the completion are added to the deck plan descriptor. For example, the deck generation module 114 may parse or process the text of the completion and identify page ID's in the form of “[n]”, where n is an integer. Alternatively, the deck generation module 114 may assign page ID numbers to the page outlines based on, for example, the order in which the page outlines are present in the completion.

For each page ID, the deck generation module 114 identifies a respective page type by identifying the location of the page type in the output format provided in the configuration data and then identifying the portion of the completion that matches that location in the output. For example, if the output format is [Page number]<type>:<headline>, the deck generation module 114 parses the text of the completion to identify a term following the [page number]. In other embodiments, the page type may be identified by matching the terms in the completion to possible page types (e.g. title, paragraph, list, quote, thank_you).

For each page outline, the deck generation module 114 also identifies a respective headline by identifying the location of the headline in the output format provided in the configuration data and then identifying the portion of the completion that matches that location in the output. For example, if the output format is [Page number]<type>:<headline>, the deck generation module 114 determines that the headline component of the page outline is provided after the page type and colon. Accordingly, it may parse the completion to identify a string of characters following the respective page type and/or following a colon (“:”) character.

Alternative parsing, text analysis, and processing techniques are also possible to identify the page type and headlines in the completion.

Once the individual components of the page outline are determined, the deck generation module 114 stores the page IDs, corresponding page types, and page headlines in the deck plan descriptor as described above. For example, it may store the page outlines in an array of page outlines with each instance in the array having a page ID, a page type, and a page headline. The method 400 then ends.

It will be appreciated that in method 400, it is presumed that the configuration data is provided to the ML system 130 each time new page outlines are required. However, this need not be the case in all implementations. In other implementations, the page outline configuration data may be provided to the ML system 130 each time an instance of the ML system 130 is invoked. If the same ML system instance is then used for subsequent page outline requests, the configuration data need not be submitted to the ML system 130 again as the ML system can remember the configuration data it has been provided previously and utilize that configuration data for subsequent page outline requests. Once the ML system instance is closed or exited, it may flush the configuration data and the server application 111 may need to resend the configuration data along with a page outline request when a new instance of the ML system 130 is invoked.

Further still, it is presumed that the ML system is a general purpose LLM that has not previously been trained or configured to provide page outlines in the required manner. However, this need not be the case in all implementations. In some implementations, a specific purpose ML system may be adopted that has been trained using copious amounts of training data of input user prompts and desired output page outlines. There is no need to provide additional configuration data for such specifically trained ML systems 130 and in such cases, the page outline prompt may simply include the user prompt.

FIG. 5 illustrates an example method 500 for performing the step 308 (i.e., generating page content). Method 500 commences at step 502, where the page outlines received at step 406 are provided to the prompt generation module 113 and the prompt generation module 113 generates a set of page content prompts, each page content prompt in the set of page content prompts corresponding to a page outline of the set of page outlines.

The content of the page content prompts will depend on the type of ML system 130 being used. If the ML system 130 is a general purpose LLM, the page outline prompt includes the user input prompt, the page outlines, and configuration data, which provides instructions to the ML system 130 to generate the page content. In case the ML system 130 includes a specific model that has already been trained for the specific task of generating page content, each page outline prompt may include the user input prompt and the corresponding page outline.

The precise format of the configuration data for page content depends on a variety of factors, including the type of LLM (e.g. configuration data for use with OpenAI's ChatGPT may differ from the configuration data required for Google's Bard), the training mechanism of the ML model, and the page type.

In one example, the page content configuration data may include a task description (e.g., to generate page content given a page outline), task parameters (e.g., output format, tone of the output, rules, etc.), and one or more training examples of input prompts and the page content the ML system 130 is expected to generate based on the input prompts.

In one example, the page content configuration data may be different for different types of pages. This is because different types of data may be desirable for different page types. For example, for a list type slide page it may be desirable to have short bullet points with an image, but for a quote type page it may be desirable to have an inspirational quote and no image. Similarly, for a title page additional text content may not be required, instead a single image may be more appropriate. Accordingly, different number of words, characters, sentences, or bullet points may be suitably specified for different page types.

Examples of different types of page content configuration data for different page types are displayed in the tables below. Table I shows the configuration data for a paragraph type page for which text content and an image is desirable. In this case, the parameters of the configuration data indicate that a media query and text content is required and specify some rules around the format of the content.

TABLE I
Example page content configuration data for ‘paragraph’ type page

| | |
|---|---|
| Description of task: | Generate text content and a media query phrase for a page on a topic |
| | given a prompt and a headline. |
| Parameters: | Be helpful and creative, and do not use offensive language |
| | The output must be formatted as: “- query: the query phrase”; “- |
| | content: the text content”.” |
| | The query should be a 3 word phrase; |
| | the content should be a paragraph with maximally 150 characters; |
| Examples: | Input: |
| | prompt: \″\″\″A six page presentation about healthy eating |
| | habits\″\″\″ |
| | headline: \″\″\″Fueling Your Body Right: Healthy Eating |
| | Tips\″\″\″ |
| | Simulated desired (query) output: |
| | query: \″\″\″woman eating carrot\″\″\″ |
| | Simulated desired (paragraph) output: |
| | content: \″\″\″Eat fresh fruits, vegetables, whole grains, lean |
| | proteins, and healthy fats for optimal nutrition ... It has been |
| | shown that ... \″\″\″ |

Table J shows the configuration data for a ‘title’ type page for which only an image is desirable. In this case, the parameters of the configuration data indicate that a media query is required and specify some rules around the format of the media query.

TABLE J
Example page content configuration data for ‘title’ type page

| | |
|---|---|
| Description of task: | Generate a short media query phrase for a page on a topic given a |
| | prompt and a headline. |
| Parameters: | Be helpful and creative, and do not use offensive language |
| | The output must be formatted as: “- query: the query phrase”; “- |
| | content: the text content”.” |
| | The query should be a 3 word phrase; |
| Examples: | Input: |
| | prompt: \″\″\″A six page presentation about healthy eating |
| | habits\″\″\″ |
| | headline: \″\″\″Fueling Your Body Right: Healthy Eating |
| | Tips\″\″\″ |
| | Simulated desired (query) output: |
| | query: \″\″\″woman eating carrot\″\″\″ |

Table K shows the configuration data for a ‘quote’ type page for which only text content is desirable. In this case, the parameters of the configuration data indicate that text content is required and specify some rules around the format of the text content.

TABLE K
Example page content configuration data for ‘quote’ type page

| | |
|---|---|
| Description of task: | Generate text content for a page on a topic given a prompt and a |
| | headline. |
| Parameters: | Be helpful and creative, and do not use offensive language |
| | The content should be a single sentence, inspirational quote based on |
| | the input prompt; |
| Examples: | Input: |
| | prompt: \″\″\″A six page presentation about healthy eating |
| | habits\″\″\″ |
| | headline: \″\″\″Fueling Your Body Right: Healthy Eating |
| | Tips\″\″\″ |
| | Simulated desired (content) output: |
| | content: \″\″\″Eating nutritious food is the foundation of a happy, |
| | healthy life.\″\″\″ |

Table L shows the configuration data for a ‘list’ type page for which text content and an image is desirable. In this case, the parameters of the configuration data indicate that a media query and text content is required and specify some rules around the format of the text content.

TABLE L
Example page content configuration data for ‘list’ type page

| | |
|---|---|
| Description of task: | Generate text content and a media query phrase for a page on a topic |
| | given a prompt and a headline. |
| Parameters: | Be helpful and creative, and do not use offensive language |
| | The output must be formatted as: “- query: the query phrase”; “- |
| | content: the text content”.” |
| | The query should be a 3 word phrase; |
| | The content should contain exactly three short, single sentence bullet |
| | points separated by an asterisk (*), all based on the input prompt |
| Examples: | Input: |
| | prompt: \″\″\″A six page presentation about healthy eating |
| | habits\″\″\″ |
| | headline: \″\″\″Fueling Your Body Right: Healthy Eating |
| | Tips\″\″\″ |
| | Simulated desired (query) output: |
| | query: \″\″\″woman eating carrot\″\″\″ |
| | Simulated desired (paragraph) output: |
| | content: \″\″\″Eat a balanced diet. * Limit your intake of |
| | carbohydrates. * Do not eat at least 3 hours before sleep |
| | time. *\″\″\″ |

Table M shows the configuration data for a ‘thank_you’ type page for which text content is desirable. In this case, the parameters of the configuration data indicate that text content is required and specify some rules around the format of the text content.

TABLE M
Example page content configuration data for ‘thank_you’ type page

| | |
|---|---|
| Description of task: | Generate text content for a page on a topic given a prompt and a |
| | headline. |
| Parameters: | Be helpful and creative, and do not use offensive language |
| | Generate content for the last slide of a presentation slide on a topic |
| | given a prompt. |
| | The content must include a single sentence thank you text |
| Examples: | Input: |
| | prompt: \″\″\″A six page presentation about healthy eating |
| | habits\″\″\″ |
| | headline: \″\″\″Fueling Your Body Right: Healthy Eating |
| | Tips\″\″\″ |
| | Simulated desired (paragraph) output: |
| | content: \″\″\″Thank you for your time and attention! \″\″\″ |

Whilst the method 500 will be described with further reference to these examples, it will be appreciated that many different types of pages and configuration data are possible.

In some embodiments, the same configuration data may be used to configure the ML system 130 to generate page content for a page type every time. In such cases, the page content configuration data for each possible page type may be predefined and stored in data storage 119. In other embodiments, the configuration data may vary (e.g., depending on user requirements). For example, a user may provide a tone for the deck (e.g., funny) that overrides the preset tone for the page content. In this case, the parameters of the configuration data may be updated to include the user input tone.

At step 502, the prompt generation module 113 retrieves the page outlines from the deck plan descriptor, identifies the page type for each page outline (e.g., by checking the page type field in the page outline) and then retrieves the corresponding configuration data for the identified page type. For example, if a deck includes 5 page outlines of the following types-title, quote, paragraph, list, and thank_you, the prompt generation module 113 retrieves the configuration data for the title, quote, paragraph, list, and thank_you type pages.

The prompt generation module 113 may then determine whether the configuration data for any of the page outlines needs to be updated (e.g., based on the received user input) and updates the corresponding configuration data (if required). The prompt generation module 113 then generates the page content prompts for each page outline. To do so, for each page content prompt, it retrieves the user input prompt from the deck plan, the headline of the corresponding page outline, and configuration data. It then constructs a text string from one or more component parts of the configuration data, the user input prompt, and the headline for the corresponding page outline (e.g. by concatenating the component parts, user input prompt, and headline together).

At step 504, once the page content prompts are generated, the prompt generation module 113 communicates the page content prompts to the ML module 112. The ML module 112 then communicates the page content prompts to the ML system 130. In some embodiments, the page content prompts may be communicated simultaneously to the ML system 130. In other embodiments, the page content prompts may be communicated sequentially—e.g., after receiving the ML system is output for a previous page content prompt.

By way of the page configuration data, the ML system 130 is cued to generate page content for each page based, in part, on the user prompt and the page headline. For example, based on the example configuration data shown in tables I-M, the ML system 130 may be cued to generate media queries for certain page types (e.g., title, paragraph and list pages), generate text content for certain page types (e.g., quote, paragraph, list, and thank_you pages). The ML system 130 outputs the page content in accordance with the corresponding page content prompt.

At 506, the page content output by the ML system 130 for each page content prompt is received by the ML module 112 as a string of output text, referred to as a completion. The page text content (if included) may be a paragraph, a sentence, or bullet points of text for display on a corresponding page in the output deck. The media queries (if included) may be a short string of text for use as a search query in retrieving a media item for display on the corresponding page in the output deck.

At 508, the page content for each page content prompt is added to the deck plan descriptor. For example, the deck generation module 114 may parse or process the text of the completion and identify the respective elements in each completion (query and/or text content) based on the required format in the corresponding configuration data. Different processing techniques may be used for each page type to identify the respective elements in each completion. For example, if the format specified in the configuration data states that the output format for text content is “content:<media query>”, the deck generation module 114 may parse or process the text of each completion and identify text content, for example, by identifying a string of text following the term “content:” in the completion. Similarly, if the format specified in the configuration data states that the output format for media queries is “query:<media query>”, the deck generation module 114 may parse the text of a completion and identify media queries, for example, by identifying a string of text following the term “query:” in the completion. Alternative parsing, text analysis, and processing techniques are also possible to identify the page content in completions.

Once the text content and/or media queries are identified in each completion, the content is stored in the deck plan descriptor against the corresponding page plan as described previously. Where a page plan of a particular type does not include a media query or text content, the deck plan may omit that attribute or include a null value for that attribute. The method 500 then ends.

Following on from the above example of a user prompt of “a pitch deck for my yoga homestay start-up” and the resulting 8 page outlines, a page content prompt may be generated for each page (as at 502) by combining the user prompt, respective page headline, and page plan configuration components according to the page type. The page content prompts are then passed to the ML system 130 (as at 504) which generates page content for each page.

The 8 raw page contents may be as shown in the table below—

TABLE N
Example page content outputs for 7 example pages of a deck

| | |
|---|---|
| Namaste | “query: \″\″\″yoga mat outdoor\″\″\″”. |
| Homestay: A | |
| wellbeing Escape. | |
| Problem statement | “content: \″\″\″with stress levels at an all-time high, our homestay |
| | start-up offers a unique solution to help people disconnect and |
| | find inner peace through yoga and mindfulness practices.\″\″\″” |
| Target Market | “query: \″\″\″meditating women\″\″\″, content: \″\″\″* Target |
| | individuals who are interested in wellness and mindfulness. * |
| | Appeal to those who are looking for an escape from the hustle and |
| | bustle of city life. * Cater to people who are seeking a unique and |
| | personalized experience.\″\″\″”; |
| Our yoga retreat | “query: \″\″\″group yoga pose\″\″\″, content: \″\″\″* Our homestay |
| | offers a peaceful and stress free environment for practicing yoga. |
| | * Experienced yoga instructors will lead daily classes for all |
| | levels. * Enjoy healthy meals made with locally sourced |
| | ingredients after your practice.\″\″\″” |
| Financials | “query: \″\″\″yoga mat and money\″\″\″, content: \″\″\″Our |
| | homestay offers affordable yoga experiences for all levels. |
| | Revenue streams include lodging fees, yoga classes and |
| | merchandise sales.\″\″\″” |
| Our team | “query: \″\″\″yoga team members\″\″\″, content: \″\″\″* Our team |
| | consists of certified yoga instructors with years of experience. * |
| | We have a dedicated team of hospitality professionals to ensure a |
| | comfortable stay for our guests. * Our team is committed to |
| | providing a safe and welcoming space for individuals to practice |
| | yoga and mindfulness.\″\″\″” |
| Amenities | “query: \″\″\″yoga mat icon\″\″\″, content: \″\″\″* Yoga mats and |
| | props provided. * Healthy vegetarian meals made with locally |
| | sourced ingredients. * Comfortable and peaceful accommodation |
| | with stunning views.\″\″\″” |
| Thanks | “content: \″\″\″We appreciate your consideration and look forward |
| | to the opportunity to share our vision with you further. Thank |
| | you!\″\″\″” |

It will be appreciated that in method 500, it is presumed that the configuration data is provided to the ML system 130 each time new page content is required. However, this need not be the case in all implementations. In other implementations, the page content configuration data for all the different page types may be provided to the ML system 130 each time an instance of the ML system 130 is invoked. If the same ML system instance is then used for subsequent page content requests, the configuration data need not be re-submitted to the ML system 130 as the ML system 130 can remember the configuration data it has been provided previously and utilize that configuration data for subsequent page content requests. Once the ML system instance is closed or exited, it may flush the configuration data and the server application 111 may need to resend the configuration data for all page types along with a page outline request when a new instance of the ML system 130 is invoked. Further, whilst page content has been described as being generated by providing separate respective page content prompts (e.g. user input prompt and respective page headline, and page configuration data) to the ML system 130, in some embodiments, a single page content prompt may be generated for all the pages or for all the pages of the same page type.

Further still, it is presumed that the ML system is a general purpose LLM that has not previously been trained or configured to provide page content in the required manner. However, this need not be the case in all implementations. In some implementations, a specific purpose ML system may be adopted that has been trained using copious amounts of training data of page types, headlines and user prompts and desired output page content. There is no need to provide additional configuration data for such specifically trained ML systems 130 and in such cases, the page content prompt may simply include the user prompt and page headline.

FIG. 6 illustrates an example method for performing step 310 (i.e., retrieving media items) according to some embodiments of the present disclosure. The method 600 commences at step 602, where the media retrieval module 116 retrieves all media queries from the deck plan descriptor. In some embodiments, the media retrieval module 116 may first determine whether the deck plan descriptor includes any media queries. For example, media retrieval module 116 may inspect the media query fields in page plans of the deck plan descriptor to check if they contain non-null values to determine that the deck plan includes media queries. If the media retrieval module 116 determines that no media queries are present in the deck plan descriptor, the method 600 ends. Alternatively, if the media retrieval module 116 determines that the deck plan includes one or more media queries, it retrieves the media queries and corresponding page plans from the deck plan descriptor.

At 604, the media retrieval module 116 selects a first media query from the list of one or more media queries and uses this media query to search a media library (e.g. media library 120 stored in data storage 119) to identify a media item that matches the media query. In one example, the media retrieval module 116 may pass the media query to the data application 118, which performs a search in the data storage 119 for one or more media items that match the media query. The data application 118 communicates the identified media items to the media retrieval module 116.

At 606, the media retrieval module 116 selects a media item from the results. In one example, the module 116 may select the first media item in the list of media items (as it may likely have the highest match percentage to the media query). In other examples, the media retrieval module 116 may randomly select a media item from the list of media items (in case all the media items equally match the media query).

At 608, media retrieval module 116 determines whether the selected media item has already been selected at step 606 for another media query associated with the deck plan descriptor. For example, media items may each have a corresponding media item ID and when a media item is selected, the media item ID for the selected media item may be stored in the deck plan descriptor in association with the corresponding media query and page plan. At step 608, the media retrieval module 116 may compare the media item ID of the media item selected at step 606 with the media item IDs already stored in the deck plan descriptor to determine whether the currently selected media item has previously been selected for another media query or page plan in the deck.

If at step 608, the media retrieval module 116 determines that the selected media item is not a duplicate media item, as is necessarily the case for the first media item selected, at step 610 the media item is assigned to the relevant page plan in the deck plan descriptor. Assigning the media item to the page plan may include storing the media item identifier in the deck plan descriptor against the corresponding page plan. For example, the media items and/or media item identifiers may be stored in the deck plan descriptor by populating respective fields of a corresponding page plan in the deck plan descriptor. In some embodiments, storing the media and/or media item identifier may further include retrieving and storing metadata of the media item, for example, the media item's resolution and/or aspect ratio in (respective fields of page records in) the deck plan descriptor.

The method then proceeds to step 612, where the media retrieval module 116 determines whether all media queries have been processed and corresponding media items selected and assigned to page plans. If it is determined that one or more media queries have not yet been processed (i.e., media items have not been selected for the one or media queries), the method 600 reverts to step 604 and steps 608-612 are repeated until all media queries have been processed.

Returning to step 608, if at this step the currently selected media item is determined to be a duplicate media item, for example, because it is determined that the selected media item has the same media item ID as another media item already stored in the deck plan descriptor, the method proceeds to step 614 where an alternative media item is searched for using the current media query. The method loops back to step 606 and retrieves an alternative media item from the results (e.g., the next media item in the list of media items or another randomly selected media item from the list of media items) until a non-duplicate media item is selected for the media query.

Continuing again with the example mentioned above of a deck plan for “a pitch deck for my yoga homestay start-up”, retrieving media items, may include retrieving images for each of pages 1, 3, 4, 5, 6 and 7. As pages 2 and 7, in this example, have null values for their query (in accordance with the configuration of their respective page type), these pages do not require images. In order to retrieve images for pages 1, 3, 4, 5, 6 and 7, their respective media queries are retrieved and used to search the media library 120 for an image to associate with the respective page. For example, the media library 120 may be searched using the queries “yoga mat outdoor”, “meditating women”, “group yoga pose”, “yoga mat and money”, “yoga team members”, and “yoga mat icon”. If the media queries “group yoga pose” and “yoga team members” result in the same top media result, the media retrieval module 116 may utilize the top media result for the “group yoga pose” query and select the next media result for the “yoga team members” query.

It will be appreciated that checking for duplicate images is an optional step. In some cases, if using the same media items multiple times in a deck is permissible, method steps 608 and 614 may be omitted. Further, although method 600 describes that the media items are retrieved from a media library maintained by the server system 110, this need not be the case in all implementations. In other examples, the media retrieval module 116 may perform a search for media items in external media stores (maintained by third parties).

Whilst steps 604-614 are illustrated as a loop of sequential decisions and steps, alternative implementations of retrieving media items are possible. For example, it is also possible to search a media library using all of the media queries and retrieving respective media items from the respective results before determining whether any duplicate media items were retrieved. That is, media item retrieval may be performed for all relevant pages in parallel or may be performed sequentially, with any duplicate media items between pages being discarded and alternate items retrieved.

Referring now to FIG. 7, it describes an example method 700 for generating and outputting a deck design (step 312 of FIG. 3).

The method commences at 702, where the deck generation module 114 retrieves the deck plan descriptor updated at the end of method step 310.

At step 704, the deck generation module 114 analyses the deck plan descriptor to generate analysis data. For example the deck generation module 114 may analyse the deck plan descriptor to determine the presence, type, length, size, quantity, and/or length of each page plan element (e.g. headline, text content, and/or media items) for each page. Analysis data may be hierarchical. Each page plan element may be considered an analysis object and may be analysed to determine analysis data for each element. For example, each element on a page may be analysed to determine if it is a text element or a media element. Text elements may be analysed as being, for example, one of a heading, a sub-heading, or body text. Body text elements may be analysed as being, for example, one of a sentence, a paragraph, or bullet points. Additionally the number of characters in a sentence, and the number of sentences in a paragraph and the number of bullet points in an element may be determined. Media items may be analysed as being, for example, one of an image, a shape, or a video. Media items may be analysed to determine their dimensions, aspect ratio, and/or resolution. The analysis data of all analysis objects on a page may be aggregated to generate analysis data of the respective page.

In some embodiments, the page analysis data for a particular page includes:
A set of one or more analysis objects. Each analysis object is associated with an element of the page (headline, text content and/or media item) and provides information concerning that element.
A page partition key that provides a first (and relatively general) measure of the types and amounts of content on the page.
A page vector that provides a second (and more specific) measure of the types and amounts of content on the page.
Page content metrics, which provide a third measure of the types and amounts of content on the page.

Analysis data of all pages in a deck plan may be aggregated to generate analysis data of the deck plan. In some embodiments, the deck generation module 114 may generate the analysis data for the deck according to method 500 described with reference to FIG. 5 of Australian provisional application number 2023210536, titled “Systems and methods for processing designs”, filed on 31 Jul. 2023, which is incorporated herein by reference.

The analysis data may then be used to match the deck plan to one or more deck-format design template 122 stored in data storage 119 at step 706. Each of the design templates 122 may also have been analysed in a similar manner to determine analysis data for each of the design templates 122. The analysis data associated with design templates 122 may be stored along with the design templates 122 in the data storage 119.

At 706, the deck generation module 114 compares the analysis data for the deck plan with the analysis data of design templates 122 to identify one or more design templates that may be compatible with the content of the deck plan. The comparison may include comparing the values of the analysis objects in the design templates with the values of the analysis objects in the deck plan. Design templates that have analysis object values that match the analysis object values of the deck plan are selected as compatible templates. The compatible templates may be either deck templates of predefined sets of compatible page templates or alternatively, individual compatible page templates may be identified for each respective page in the deck plan.

For example, for the deck plan for “a pitch deck for my yoga homestay start-up”, a compatible design template may be a design template that includes a title page that can accommodate a heading and a media item, a body page that can accommodate a single quote, another body page that can accommodate a paragraph and a media item, another body page that can accommodate a list and a media item, and a conclusion page that can accommodate a paragraph. That is, each compatible design template 122 should include destination page elements configured to receive, position and display the page elements of the respective pages.

Once compatible design templates are identified, a design template is selected. If only one compatible design template is identified at step 706, that design template may be automatically selected at step 708. Alternatively, if a set of compatible design templates are identified, one design template may be selected from the set. The selection may be done based on one or more predefined criteria—e.g., the most compatible design template (if compatibility scores are computed and available) may be selected, or the first design template in the set may be selected.

In some embodiments, the user may select the design template. In such embodiments, if a set of compatible design templates are identified, the server application 111 may communicate the set of identified compatible design templates to the client application 142 for displaying on the client system for user selection.

At step 710, the page elements of the deck plan are transferred into the selected design template, that is, the page elements of each page (i.e., text content, and/or media items) are transferred into corresponding destination elements of the selected design template. The design template may thus provide a structure for where elements such as text and images may be positioned for display in the output deck. In addition to positioning elements for display, templates may also apply stylistic elements, for example, fonts and colours, either to individual elements and/or as a palette across the deck.

At 712, the generated deck-format design is communicated to the client application 142 for display on the client system 140.

Although method 700 describes selection of a single design template at step 708, this may not be the case in all implementations. In some embodiments, multiple compatible design templates may be selected and populated with the deck plan to present multiple candidate deck-format designs to the user for their preferred selection of the final deck.

Further, once the final deck is created, a deck record 124 is generated for the deck and stored in the data storage 119. In some embodiments, the deck record 124 may be temporarily stored in a cache. If the user is not satisfied with the deck and starts process 300 again, the deck record 124 may be deleted. Alternatively, if the user is satisfied with the deck and explicitly saves it, the server application 111 may store the data record in the data storage 119.

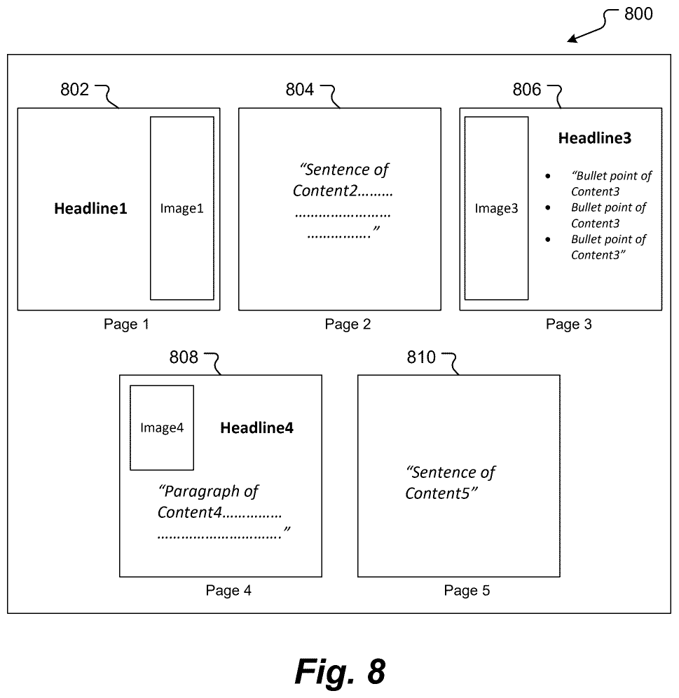

FIG. 8 shows an example deck-format design 800 generated and displayed on the client system 140 at the end of method 300. In this example, the deck-format design 800 has 5 pages 802-810 including a title page 802 having a headline and an image, a quote page 804 having a single quotation, a body page 806 including a headline, a list and an image, another body page 808 including a headline, a paragraph and an image, and a conclusion page 810 having a single sentence.

The generated design 800 may further be output in an editable format to allow a user to modify the design. While not shown, application 142 may display (or otherwise provide access to) additional controls that allow a user (e.g. via application 142) to view and edit the generated and output design 800. Such controls may, for example, enable a user to perform operations such as: adding new pages; deleting pages; reordering pages; adding an element to a particular page; removing an element from a particular page (including removing element that have been automatically generated for the page); editing an element that has been added to a particular page (including editing the elements that have been automatically generated for the page); and/or other operations.

Application 142 may also provide a user with various options for exporting the output design 800. This may include, for example, one or more options that allow a user to: determine an export location (e.g. on local memory such as 210 or a network accessible storage device); determine an export format (e.g. a file type); determine an export size/resolution; and/or other export options.

Application 142 may further provide a user with various options to share the design 800. This may include, for example, one or more options that allow a user to determine a format (e.g. file type) and then share the resulting design (e.g. by attaching it to an electronic communication, uploading to a web server, uploading to a social media service, or sharing in an alternative manner). Application 142 may also provide a user with the option of sending a link (e.g. a URL) to the design (e.g. by generating a link and attaching a link to an electronic communication or allowing a user to copy the link).

In the embodiments described above, a deck-format design includes a set of pages. However, in some embodiments, the deck-format design may include a single page without departing from the scope of the present disclosure. In this case, the methods described above are performed (albeit with slight modifications) to generate a page outline for a single page, generate page elements for a single page, and select a design template for a single page design.

Further still, although a deck-type design is described, the systems and methods described herein need not be limited to automatically generating deck-format designs. In other examples, document format designs or even posts can be generated in a similar manner based on input user prompts without departing from the scope of the present disclosure. In case a document format design is selected, the instead of page outlines and page plans, the systems and methods may generate document sub-headings and content (including text and/or images, charts, etc.) corresponding to those sub-headings.

The flowcharts illustrated in the figures and described above define operations in particular orders to explain various features. In some cases the operations described and illustrated may be able to be performed in a different order to that shown/described, one or more operations may be combined into a single operation, a single operation may be divided into multiple separate operations, and/or the function(s) achieved by one or more of the described/illustrated operations may be achieved by one or more alternative operations. Still further, the functionality/processing of a given flowchart operation could potentially be performed by (or in conjunction with) different applications running on the same or different computer processing systems.

The present disclosure provides various user interface examples. It will be appreciated that alternative user interfaces are possible. Such alternative user interfaces may provide the same or similar user interface features to those described and/or illustrated in different ways, provide additional user interface features to those described and/or illustrated, or omit certain user interface features that have been described and/or illustrated.

In the above description, certain operations and features are explicitly described as being optional. This should not be interpreted as indicating that if an operation or feature is not explicitly described as being optional it should be considered essential. Even if an operation or feature is not explicitly described as being optional, it may still be optional.

Unless otherwise stated, the terms “include” and “comprise” (and variations thereof such as “including”, “includes”, “comprising”, “comprises”, “comprised” and the like) are used inclusively and do not exclude further features, components, integers, steps, or elements.

In certain instances the present disclosure may use the terms “first,” “second,” etc. to describe various elements. Unless stated otherwise, these terms are used only to distinguish elements from one another and not in an ordinal sense. For example, a first element or feature could be termed a second element or feature or vice versa without departing from the scope of the described examples. Furthermore, when the terms “first”, “second”, etc. are used to differentiate elements or features rather than indicate order, a second element or feature could exist without a first element or feature. For example, a second element or feature could occur before a first element or feature (or without a first element or feature ever occurring).

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage, or attribute that is not expressly recited in a claim should be considered as a required or essential feature. Accordingly, the specification and drawings are to be regarded in an illustrative rather than a restrictive sense.

Background information described in this specification is background information known to the inventors. Reference to this information as background information is not an acknowledgment or suggestion that this background information is prior art or is common general knowledge to a person of ordinary skill in the art.

1. A computer implemented method for automatically generating a design including one or more pages, the method including:
receiving, at a computer system, an input prompt for generating the design, the input prompt comprising a topic for the design;
generating, by the computer system, page outlines for each of the one or more pages, wherein generating each page outline includes generating a page type and a headline based on the input prompt;
generating, by the computer system, page elements for each of the pages based on the page type and the headline for each of the one or more pages, wherein the page elements includes at least one of text content or media content; and
generating, by the computer system, the design including the one or more pages based on the respective page elements, wherein each page of the design displays the page elements of the respective page.

2. The computer implemented method of claim 1, further comprising creating, by the computer system, a design descriptor, the design descriptor comprising the input prompt.

3. The computer implemented method of claim 2, wherein generating the page outlines comprises:
generating a page outline prompt, the page outline prompt comprising the input prompt;
communicating the page outline prompt to a machine learning model configured to generate the page outlines for each of the one or more pages based on the page outline prompt;
receiving the page outlines for each of the one or more pages from the machine learning model; and
updating the design descriptor to include the received page outlines.

4. The method of claim 3, wherein the page outline prompt further comprises configuration data to configure the machine learning model to generate the page outlines.

5. The computer implemented method of claim 4, wherein the configuration data includes one or more of: a task description; task parameters, and training data.

6. The computer-implemented method of claim 5, wherein the task parameters include indication of the types of pages the machine learning model can generate, and an instruction to select a design category that is utilized by the machine learning model to generate the page outlines.

7. The computer implemented method of claim 2, wherein generating the page elements for each of the pages comprises:
generating a page content prompt for each of the one or more pages, each page content prompt including the input prompt and a corresponding page headline;
communicating the page content prompt for each of the one or more pages to a machine learning model configured to generate the text content and/or a media query for each of the one or more pages based on a corresponding page content prompt;
receiving the text content and/or media query for each of the one or more pages from the machine learning model; and
updating the design descriptor to include the received text content and/or media query.

8. The computer implemented method of claim 7, wherein each page content prompt further comprising configuration data to configure the machine learning model to generate the text content and/or the media query, and wherein the content of the configuration data is based on the page type.

9. The computer implemented method of claim 8, wherein the page content configuration data includes one or more of: a task description; task parameters; and training data.

10. The computer implemented method of claim 7, further comprising:
for each media query received from the machine learning model:
performing a search for a media item using the media query;
assigning the media item to a page associated with the media query; and
updating the design descriptor to include the assigned media item.

11. The computer implemented method of claim 10, wherein performing a search for a media item comprises:
receiving a set of media items that match the media query; and
selecting a first media item from the set of media items.

12. The computer implemented method of claim 11, further comprising:
determining whether the selected media item has already been assigned to the page associated with the media query for a different media query; and
upon determining that the selected media item has already been assigned to the page associated with the media query for a different media query, selecting another media item from the set of media items.

13. The computer implemented method of claim 2, further comprising:
identifying a design template from a set of design templates that is compatible with the design descriptor; and
transferring page elements of each page of the design into corresponding destination page elements of the design template to generate the design.

14. The computer implemented method of claim 13, wherein identifying a design template from the set of design templates comprises:
analysing the design descriptor to generate analysis data, the analysis data including for each page in the design descriptor one or more of:
a set of one or more design elements in each page of the design descriptor,
a page partition key that provides a first measure of the types and amounts of content on a page,
a page vector that provides a second measure of the types and amounts of content on a page, and
page content metrics that provide a third measure of the types and amounts of content on the page.

15. The method of claim 14, wherein identifying the design template from the set of design template further comprises comparing the analysis data of the design descriptor with analysis data associated with the set of design templates to identify the design template from the set of design templates that has the most similar analysis data to the analysis data of the design descriptor.

16. The computer implemented method of claim 2, wherein the machine learning model is a generative large language model.

17. A computer processing system including:
one or more processing units; and
one or more non-transitory computer-readable storage media storing instructions, which when executed by the one or more processing units, cause the one or more processing units to perform a method including:
receiving, at a computer system, an input prompt for generating the design, the input prompt comprising a topic for the design;
generating, by the computer system, page outlines for each of the one or more pages, wherein generating each page outline includes generating a page type and a headline based on the input prompt;
generating, by the computer system, page elements for each of the pages based on the page type and the headline for each of the one or more pages, wherein the page elements includes at least one of text content or media content; and
generating, by the computer system, the design including the one or more pages based on the respective page elements, wherein each page of the design displays the page elements of the respective page.

18. The computer processing system of claim 17, wherein the the method further includes:
creating, by the computer system, a design descriptor, the design descriptor comprising the input prompt; and
wherein generating the page outlines comprises:
generating a page outline prompt, the page outline prompt comprising the input prompt;
communicating the page outline prompt to a machine learning model configured to generate the page outlines for each of the one or more pages based on the page outline prompt;
receiving the page outlines for each of the one or more pages from the machine learning model; and
updating the design descriptor to include the received page outlines.

19. One or more non-transitory storage media storing instructions executable by one or more processing units to cause the one or more processing units to perform a method including:
receiving, at a computer system, an input prompt for generating the design, the input prompt comprising a topic for the design;
generating, by the computer system, page outlines for each of the one or more pages, wherein generating each page outline includes generating a page type and a headline based on the input prompt;
generating, by the computer system, page elements for each of the pages based on the page type and the headline for each of the one or more pages, wherein the page elements includes at least one of text content or media content; and
generating, by the computer system, the design including the one or more pages based on the respective page elements, wherein each page of the design displays the page elements of the respective page.

20. The one or more non-transitory storage media of claim 19, wherein the the method further includes:
creating, by the computer system, a design descriptor, the design descriptor comprising the input prompt; and
wherein generating the page outlines comprises:
generating a page outline prompt, the page outline prompt comprising the input prompt;
communicating the page outline prompt to a machine learning model configured to generate the page outlines for each of the one or more pages based on the page outline prompt;
receiving the page outlines for each of the one or more pages from the machine learning model; and
updating the design descriptor to include the received page outlines.
